(19) United States
(12) Patent Application Publication
(10) Pub. No.: US 2009/0275292 A1
(43) Pub. Date: Nov. 5, 2009

(54) System and Method for Wireless Communications

(76) Inventor: Soo-Young Chang, Davis, CA (US)

Correspondence Address: Slater & Matsil, L.L.P., 17950 Preston Road, Suite 1000, Dallas, TX, 75252, US

(21) Appl. No.: 12/114,588

(22) Filed: May 2, 2008

(51) Int. Cl. H04B 7/005

(52) U.S. Cl. 455/69

(57) ABSTRACT

System and method for enabling the cohabitation of licensed and unlicensed communications devices. A method comprises receiving a transmission permission request from a secondary device during a first transmission slot of a first communications period, decoding the transmission permission request, responding to the transmission permission request in a second transmission slot in response to a determining that a decision on the transmission permission request has been made, and receiving a transmission in a second communications period. The transmission permission request comprises a codeword generated by concatenating two sequences shorter in length than the codeword.

### TECHNICAL FIELD

The present invention relates generally to a system and method for wireless communications, and more particularly to a system and method for enabling the cohabitation of licensed and unlicensed communications devices.

### BACKGROUND

In general, there may be two classes of electronic communications devices or simply, communications devices. A first class of communications devices may be licensed communications devices wherein the communications devices communicate over licensed spectra. Licensed communications devices typically communicate over spectrum licensed from governing or regulatory bodies and organizations, such as the Federal Communications Commission in the United States. Licensed communications devices may be able to use the licensed spectrum generally without having to consider the possibility of interference from other electronic devices or causing interference to other electronic devices operating within the licensed spectrum.

A second class of communications devices may be unlicensed communications devices wherein the communications devices communicate over spectrum that is not licensed to the devices. Unlicensed communications devices usually operate under a requirement that they do not interfere with other communications devices while being able to tolerate interference from other communications devices.

However, in some licensed spectrum, the licensed spectrum is not fully utilized and there has been a drive by regulators, developers, users, and so forth, to more fully use the valuable bandwidth. For example, in the portion of the spectrum dedicated to television transmissions, which occupies spectrum ranging from about 54 MHz to 72 MHz, about 76 MHz to 88 MHz, about 174 MHz to 216 MHz, and about 470 MHz to 806 MHz, in about 6 MHz channels, a significant portion of the available bandwidth is not being utilized. For example, within a given operating area, there may be, on average, about 5 to 20 actively transmitting television channels with the remainder of the television spectrum remaining substantially unused.

This bandwidth may be used to provide high-speed broadband access, especially in rural areas that are typically not served by cable or telephone high-speed broadband providers. The bandwidth available in the television broadcast spectrum may be used to create a wireless rural area network (WRAN). However, since this is licensed spectrum, the licensed electronic devices using the licensed spectrum must not be interfered with.

FIG. 1 is a diagram of a television broadcast network 100 having a WRAN operating in the vicinity. The television broadcast network 100 include a television (TV) broadcast tower 105 that may be used to transmit television programs to customer premises equipment (CPE), such as television sets 110-112, and so forth. The transmissions may have a practical range (a transmission coverage area 120) that may be dependent on the operating environment, such as the terrain, the presence of other television channels broadcasting over the same frequency bands, and so forth. CPE outside of the transmission coverage area 120, such as CPE 125, may not be able to receive the television program transmissions or the quality of the received television program transmissions may not be acceptable.

The WRAN may be achieved using a WRAN broadcast tower 130. The WRAN broadcast tower 130 may transmit data to and receive data from CPE capable of data communications, such as CPE 135-136. The CPE may be able to transmit and receive directly to from the WRAN broadcast tower 130. Additionally, transmissions from the WRAN broadcast tower 130 may be received by repeaters, such as repeater 140, that may be used to allow CPE, such as the CPE 125, outside of the transmission coverage area 120 the ability to receive information. The repeaters may also be able to transmit information back to the WRAN broadcast tower 130.

In addition to data capable CPE and data incapable CPE, there may be other licensed electronic equipment, such as wireless intercom systems, wireless video assist systems, wireless interrupted feedback systems, wireless microphones, and so forth. These licensed electronic devices may be referred to collectively as Part 74 devices. In FIG. 1, the Part 74 devices are illustrated as P74, such as P74 145. Since the Part 74 devices are licensed electronic equipment, their communications need to take precedence over the WRAN broadcast tower's communications with the data capable CPE.

### SUMMARY OF THE INVENTION

These and other problems are generally solved or circumvented, and technical advantages are generally achieved, by embodiments of a system and a method for enabling the cohabitation of licensed and unlicensed communications devices.

In accordance with an embodiment, a method for transmitting data is provided. The method includes generating a codeword, transmitting the codeword to a communications controller, transmitting data in response to a determining that an acknowledgment to the codeword has been received, and waiting a period of time in response to a determining that no acknowledgment to the codeword has been received. The generating includes concatenating a first portion of the codeword with a second portion of the codeword.

In accordance with another embodiment, a method for wireless communications is provided. The method includes receiving a transmission permission request from a secondary device during a first transmission slot of a first communications period, decoding the transmission permission request, responding to the transmission permission request in a second transmission slot in response to a determining that a decision on the transmission permission request has been made, and receiving a transmission in a second communications period. The transmission permission request includes a codeword generated by concatenating two sequences shorter in length than the codeword.

In accordance with another embodiment, a communications network is provided. The communications network includes a primary protecting device that controls transmissions taking place in the communications network and signals communications information to communications devices not part of the communications network for the purpose of protecting communications of communications devices associated with the communications network, and a secondary protecting device wirelessly coupled to the primary protecting device, the secondary protecting device protects a communications device associated with the communications network by transmitting communications information to the primary protecting device after obtaining permission to transmit by transmitting a codeword generated by concatenating two sequences having lengths shorter than the codeword.

An advantage of an embodiment is that a large number of unique orthogonal codewords may be provided, which may decrease the probability of transmission collisions.

A further advantage of an embodiment is that the orthogonal codewords may be easily generated by combining a relatively small number of shorter orthogonal codewords, which may reduce codeword storage requirements, codeword generation complexity, and so forth.

Yet another advantage of an embodiment is that an orthogonal codewords may be detected by separately detecting the shorter orthogonal codewords making up the orthogonal codeword. This may reduce codeword detection complexity, codeword storage requirements, power consumption, and so forth.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a television broadcast network including a WRAN operating the general vicinity;

FIG. 2 is a diagram of several wireless networks;

FIG. 3a is a diagram of a structure of a superframe of a typical beacon signal;

FIG. 3b is a diagram of a structure of an inter-device communications period;

FIG. 4a is a diagram of a transmitting portion of a protecting device;

FIG. 4b is a diagram of a receiving portion of a protecting device;

FIG. 5a is a diagram of a codeword generated by concatenating two shorter length sequences;

FIG. 5b is a diagram of a list of length eight orthogonal sequences;

FIG. 6 is a diagram of a sequence of events in the operation of a wireless network;

FIG. 7a is a diagram of a sequence of events in the generation of a codeword; and

FIG. 7b is a diagram of a sequence of events in the determining of a received codeword.

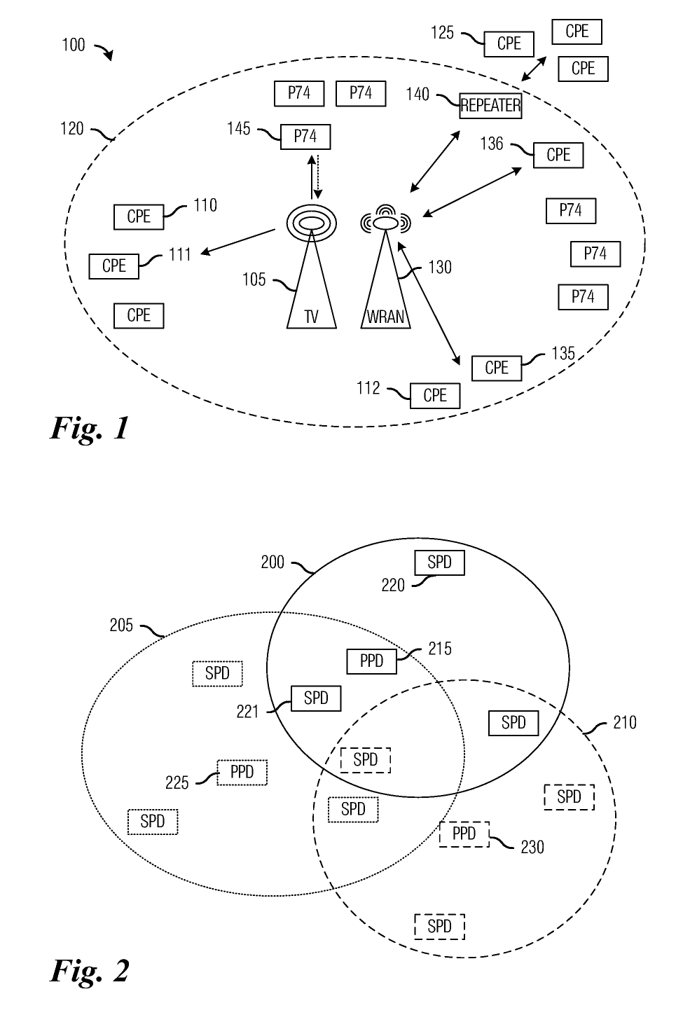

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless network compliant to IEEE 802.22 Task Group 1 (IEEE 802.22 TG1) technical standards for use in protecting communications of licensed communications devices while providing unused bandwidth to unlicensed communications devices. The invention may also be applied, however, to other wireless networks used to control access to communications media using orthogonal codewords.

FIG. 2 is a diagram of several wireless networks, such as wireless network 200, wireless network 205, and wireless network 210, compliant to the IEEE 802.22 TG1 technical standards. An IEEE 802.22 TG1 compliant wireless network, such as the wireless network 200, may be used to protect the communications of licensed communications devices, such as Part 74 devices, that are a part of a licensed network. The wireless network 200 includes protecting devices that may be used to protect licensed communications devices operating in their own wireless network, but may be associated with the protecting devices and with the wireless network 200. A protecting device may be a beaconing device that may be used to inform other electronic devices (both licensed and unlicensed) operating in the vicinity of the wireless network 200 of the presence of a licensed communications device that is being protected by the protecting device. A single protecting device may protect one or more licensed communications devices.

There may be two different types of protecting devices: a primary protecting device (PPD) and a secondary protecting device (SPD). A PPD, such as PPD 215, may be used to control the transmissions of beacons by SPDs, such as SPD 220 and SPD 221, in the wireless network 200. In addition to controlling the transmissions of beacons by SPDs in its network, the PPD 215 may also protect one or more licensed communications devices. An SPD may become a PPD if the SPD desires to create a wireless network, such as the wireless network 200, to protect licensed communications devices. Alternatively, an SPD may elect to join an existing wireless network and remain an SPD. In addition to its own protected devices, a PPD may aggregate information regarding protected licensed communications devices protected by SPDs in its wireless network and may provide this information to networks of unlicensed communications devices, such as a WRAN, operating in the vicinity. The networks of unlicensed communications devices may then take steps to avoid communicating in frequency bands being used by the protected licensed communications devices. Additionally, the transmission of beacons may inform unlicensed communications devices about the presence of protected licensed communications devices operating in the vicinity.

When an SPD, such as the SPD 220, desires to transmit its beacon, the SPD 220 may randomly select a codeword from a list of possible codewords and transmit the selected codeword within a request to send (RTS) period of a superframe. If the SPD 220 detects an acknowledgment (ACK) from the PPD 215 within an Ack/Nack period (ANP) in the superframe in which it transmitted the codeword, then the SPD 220 may transmit its beacon during a subsequent superframe. The ACK from the PPD 215 may be in the form of the codeword transmitted by the SPD 220. However, if the SPD 220 detects a negative acknowledgment (NACK) or no ACK from the PDD 215 within the ANP, then the SPD 220 may not transmit its beacon and may need to transmit a codeword in during a RTS period of another superframe after waiting a period of time to repeat its request for permission to transmit its beacon.

There may be more than one PPD in operation within a general area, with each PPD controlling its own wireless network. For example, the PPD 215 may control the wireless network 200, a PPD 225 may control the wireless network 205, a PPD 230 may control the wireless network 210, and so on. Although there may be overlap in the coverage area of the various wireless networks, an SPD may only belong to a single wireless network and may only be controlled by its own PPD. Please refer to a co-assigned patent application entitled “System and Method for Wireless Communications,” attorney docket number 08FW061, filed May 5, 2008, which patent application is incorporated herein by reference, for a detailed description of multiple access techniques allowing multiple wireless networks controlled by multiple PPDs to cohabitate without causing significant co-interference.

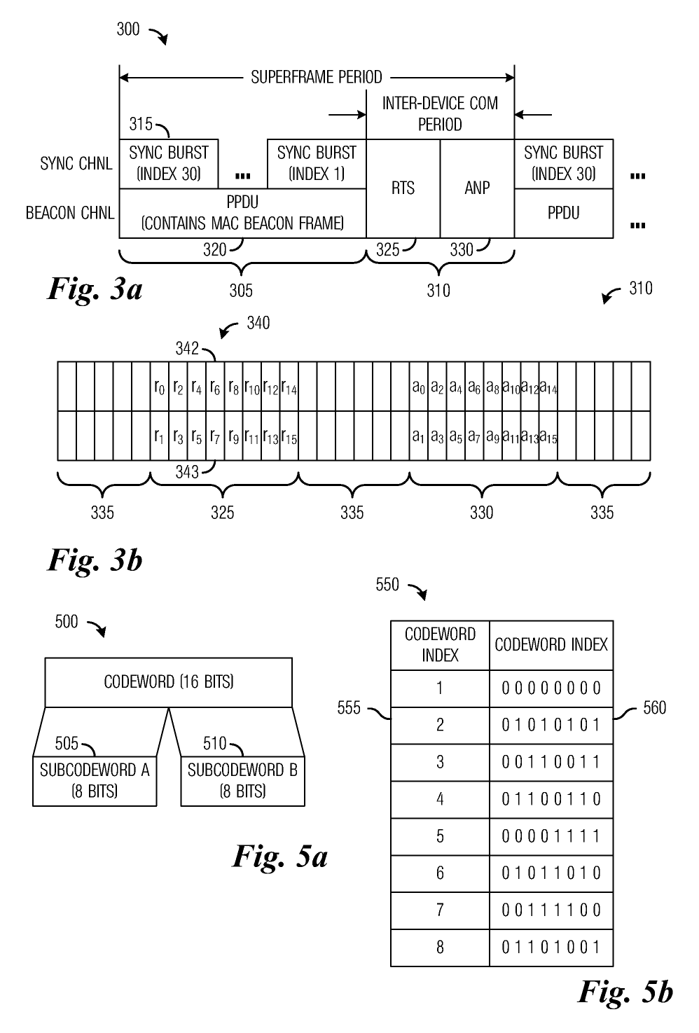

FIG. 3a illustrates a structure of a superframe 300. The communications of a wireless network may consist of a sequence of superframes. A superframe, such as the superframe 300, may include two distinct periods, a beacon data period 305 and an inter-device communications period 310. During the beacon data period 305, a synchronization channel (SYNC CHNL) may be used to transmit a number of synchronization bursts, such as the sync burst 315. There may be a total of thirty (30) synchronization bursts transmitted during the control period 305. During the beacon data period 305, a new protecting device may become synchronized with other protecting devices using the synchronization bursts.

Additionally, during the beacon data period 305, a beacon channel (BEACON CHNL) may be used to transmit a PHY protocol data unit (PPDU) 320, which may include a beacon. A PPD, such as the PPD 225, may continuously transmit (broadcast) its beacon frames after it aggregates information from SPDs in its wireless network. These beacon frames may be received by WRANs operating in the vicinity as well as SPDs. They may decode the beacon frames to obtain information pertaining to licensed communications devices associated with a wireless network controlled by the PPD 225.

The inter-device communications period 310 may include a RTS period 325 and an ANP 330. The RTS period 325 may be used by any SPD, such as the SPD 220, to transmit a randomly selected codeword to a PPD, such as the PPD 215, requesting permission to transmit a beacon in a subsequent superframe. Since the codewords are orthogonal sequences, multiple codewords may be transmitted without collision if different codewords are selected. The PPD 215 may then respond to the SPD 220 during the ANP 330 with an ACK (granting permission to transmit the beacon), a NACK (denying permission to transmit the beacon), or by not transmitting anything (also denying permission to transmit the beacon). The ACK/NACK may be addressed to specific SPDs allowing/disallowing permission to transmit. If there were multiple detectable codewords transmitted during the RTS period 325, the PPD 215 may determine one of the SPDs to grant transmission permission and then during the ANP 330, the PPD 215 may transmit the codeword corresponding to the SPD that was granted permission to transmit.

FIG. 3b illustrates a detailed view of the inter-device communications period 310. In addition to the RTS period 325 and the ANP 330, the inter-device communications period 310 may include guard intervals 335 located before the RTS period 325, between the RTS period 325 the ANP 330, and after the ANP 330. The guard intervals 335 may allow for switching time between listen mode and transmit mode, help prevent data from the separate periods from contaminating each other, and so forth. The RTS period 325 and the ANP 330 may each include eight symbols with each symbol encoded using quadrature phase shift keying modulation (QPSK), thereby representing two-bits of data per symbol for a total of 16 bits of data. For example, a symbol 340 in the RTS period 310 may represent bits r₆ 342 and r₇ 343 of the RTS period 310.

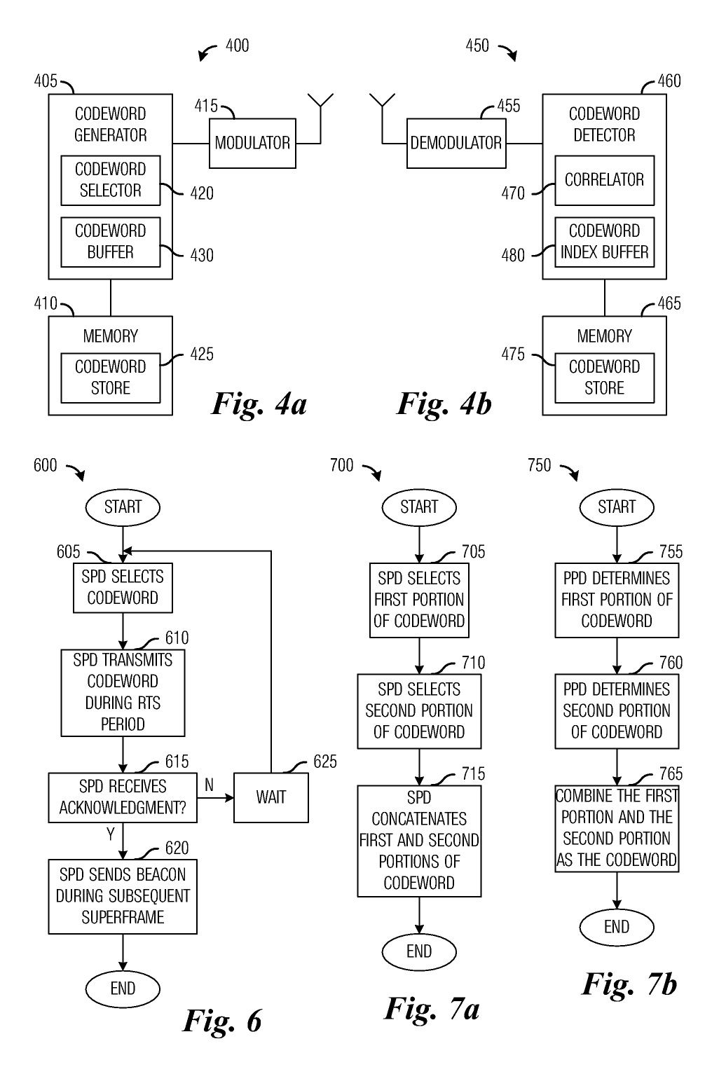

FIG. 4a illustrates a high-level view of a portion of a transmitter 400. The transmitter 400 includes a codeword generator 405, a memory 410, and a modulator 415. The codeword generator 405 may be used to generate a codeword for transmission during a RTS period, such as the RTS period 325. The codeword generator 405 include a codeword selector 420 that may select a first portion of the codeword from a codeword store 425 located in the memory 410 and then storing the first portion of the codeword in a codeword buffer 430. After selecting and storing the first portion of the codeword, the codeword selector 420 may then select a second portion of the codeword from the codeword store 425. The codeword may now be complete and may be provided to the modulator 415 that may modulate the codeword for transmission purposes, such as over-the-air using an antenna.

As discussed previously, the codeword selected by an SPD for transmission during the RTS period 325 may be a 16-bit long codeword. Preferably, the codewords are orthogonal to each other, meaning that multiple codewords may be transmitted at the same time without the codewords interfering with one another. In general, the codewords are orthogonal to one another if for a set of codewords

$$\{ {f}_{i} , i = 1 , 2 , 3 , … \} {f}_{i} , {f}_{j} = {\sum }_{k = 1}^{m} {f}_{i} ( k ) {f}_{j} ( k ) = {‖ {f}_{i} ‖}^{2} {δ}_{ij} = {‖ {f}_{j} ‖}^{2} {δ}_{ij}$$

$$where$$

$${δ}_{ij} = \{ \begin{matrix}1 if i = j \\ 0 if i \neq j\end{matrix} \} .$$

Orthogonal sequences of length 16 may be used for the codewords. The length 16 orthogonal sequences may be predetermined and stored in the transmitter 400 for subsequent use. Alternatively, it may be possible to dynamically create orthogonal sequences of length 16 by concatenating two orthogonal sequences of length eight (8), four orthogonal sequences of length four (4), eight orthogonal sequences of length two (2), one orthogonal sequence of length eight (8) and two orthogonal sequences of length four (4), or so forth. Concatenating orthogonal sequences having the same length may enable a simple selection of the orthogonal sequences of a single length rather than storing different length orthogonal sequences. For example, when two orthogonal sequences of length eight are used to create a single orthogonal sequence of length 16, it may be possible to select a first orthogonal sequence of length eight from a set of possible orthogonal sequences of length eight and then select a second orthogonal sequence of length eight from the same set of possible orthogonal sequences of length eight. By doing this, only one set of possible orthogonal sequences may need to be stored, thereby reducing storage requirements. Similarly, for orthogonal sequence of length 16 created from four orthogonal sequences of length four, only one set of possible orthogonal sequences of length four needs to be stored and the four orthogonal sequences of length four may be selected from the one set. The set of possible sequences may be stored in the codeword store 425, which may be located in the memory 410 or it may be its own dedicated memory.

FIG. 4b illustrates a high-level view of a portion of a receiver 450. The receiver 450 includes a demodulator 455, a codeword detector 460, and a memory 465. The demodulator 455 may be used to decode a received signal transmitted over-the-air by a transmitter and received at the receiver 450 by an antenna. The codeword detector 460 may be used to determine a codeword(s) transmitted by one or more SPDs. The codeword detector 460 includes a correlator 470. The correlator 470 may compute a correlation value between a test orthogonal sequence (test codeword) stored in a codeword store 475 and a received orthogonal sequence (received codeword). The correlator 470 may repeat the computation of correlation values for each possible test orthogonal sequence with the received codeword and the test codeword producing the highest correlation value is selected as the orthogonal sequence (e.g., the codeword) received. Since the number of computation performed by the correlator 470 may be dependent on the number of possible test codeword, large numbers of test codewords may increase the amount of time required to detect the received codeword. Furthermore, the amount of computation required to perform a correlation may also be dependent on the length of the test codeword, therefore, shorter test codeword may require fewer computations.

Correlating a test codeword with a received codeword that was created by concatenating multiple shorter length orthogonal sequences may occur in multiple stages, with each stage involving correlating an appropriate length test orthogonal sequence with a portion of the received codeword. For example, for a received codeword created by concatenating two shorter orthogonal sequences (a first orthogonal sequence and a second orthogonal sequence), a first stage of the correlating may involve correlating possible orthogonal sequences with the first portion of the received codeword and then a second stage of the correlating may involve correlating possible orthogonal sequences with the second portion of the received codeword. The resulting selected orthogonal sequences may then be concatenated to produce the received codeword.

For discussion purposes, let there be eight length eight orthogonal sequences that may be used to create each of two portions of a length 16 codeword. Therefore, there may be up to 64 (eight possible orthogonal sequences for a first portion and eight possible orthogonal sequences for a second portion) unique length 16 orthogonal sequences usable as codewords. Then, detecting a received codeword may involve correlating the eight possible length eight orthogonal sequences with both the first portion and the second portion, which may involve eight length eight correlations each, for a total for 16 length eight correlations. Instead, if the length 16 orthogonal sequence was selected from 64 possible length 16 orthogonal sequences for the codeword, then detecting a received codeword may involve correlating 64 possible length 16 orthogonal sequences with the received codeword, which may involve 64 length 16 correlations.

When one of the test codeword has been selected as a portion of the received codeword, an index corresponding to the test codeword may be stored in a codeword index buffer 480. For example, if result of the correlator 470 has specified that test codeword 4 has the highest correlation value, then the index 4 may be stored in the codeword index buffer 480. Alternatively, the actual test codeword may be stored in a buffer.

The codeword detector 460 may repeat the detecting of the multiple portions of the received codeword a number of times, with one detecting for each portion in the multiple portions. For example, if the received codeword was generated by concatenating two shorter length orthogonal sequences, then the codeword detector 460 may operate twice to detect a first shorter length orthogonal sequence and a second shorter length orthogonal sequence. Similarly, if the received codeword was generated by concatenating four shorter length orthogonal sequences, then the codeword detector 460 may operate four times.

FIG. 5a illustrates a length 16 codeword 500. The length 16 codeword 500 may comprise two length eight subcodewords, a length eight subcodeword A 505 and a length eight subcodeword B 510. The length eight subcodeword A 505 and the length eight subcodeword B 510 may be concatenated together to form the length 16 codeword 500. Although shown to be generated from the concatenation of two equal length orthogonal subcodewords, the codeword 500 may be generated by concatenating a variety of orthogonal subcodewords. Therefore, the illustration of two length eight orthogonal subcodewords should not be construed as being limiting to either the scope or the spirit of the embodiments.

Each of the two length eight subcodewords, the length eight subcodeword A 505 and the length eight subcodeword B 510, may be selected from eight possible length eight orthogonal sequences. Therefore, there may be up to 64 unique length 16 codewords (eight unique subcodeword A 505 and eight unique subcodeword B 510). FIG. 5b illustrates one possible set of eight length eight orthogonal sequences that may be selected for use as the subcodeword A 505 and the subcodeword B 510. For example, a second length eight orthogonal sequence “CODEWORD INDEX 2” 555 may be a sequence “0 1 0 1 0 1 0 1” 560. The length eight orthogonal sequences shown in FIG. 5b are Walsh codes of length eight. Although shown in FIG. 5b to be Walsh codes, other length eight orthogonal sequences may be used, as long as they are orthogonal and unique. Therefore, the illustration of Walsh codes should not be construed as being limiting to either the scope or the spirit of the embodiments.

Although up to 64 unique length 16 orthogonal sequences may be generated from the concatenation of the eight Walsh codes of length eight, some of the orthogonal sequences may be dedicated for special use, such as the NPD or Go-on and the NACK. Therefore, out of the 64 unique length 16 orthogonal sequences, 62 may be usable as unique codewords that may be usable as codewords during either the RTS period 325 or the ANP 330.

FIG. 6 illustrates a sequence of events 600 in the operation of a wireless network, wherein an SPD wishes to obtain permission to transmit a beacon. The sequence of events 600 may be descriptive of the operation of a wireless network, such as the wireless network 200, which may be used to protect licensed communications devices from transmissions made by unlicensed communications devices. The operation of the wireless network 200 may begin when an SPD wishes to transmit a beacon indicating the presence of a protected licensed communications device. Any unlicensed communications device that detects the beacon and is communicating over the same frequency band as the protected licensed communications device may need to stop communications over the frequency band and change to a different frequency band.

Prior to transmitting the beacon, the SPD may need to obtain permission to transmit the beacon from a PPD that is controlling the operation of the wireless network 200. To obtain permission to transmit the beacon, the SPD may select a codeword from a set of possible codewords (block 605). For example, the codeword may be a length 16 orthogonal sequence that may be generated by concatenating shorter length orthogonal sequences, as described previously. The SPD may select the codeword or indices to a list of shorter length sequences that may be concatenated to produce the selected codeword, for example.

The selection of the codeword may occur randomly, with the SPD randomly selecting one codeword out of the many possible codewords. For example, using length 16 codewords generated by concatenating two length eight orthogonal sequences with eight possible orthogonal sequences per length eight orthogonal sequence, one out of 64 possible codewords may be selected randomly.

Another technique to select the codeword may involve assigning a codeword to an SPD, wherein the assignment may correspond to a frequency band (for example, a subchannel number of an entire band) used by a protected licensed communications device being protected by the SPD. The codeword may then be assigned to the SPD and the SPD may not need to select a codeword (such as during block 605) whenever it wishes to obtain permission to transmit its beacon. If the protected licensed communications device uses multiple frequency bands (subchannels), then the codeword may be assigned based on a lowest (or highest, middle, most frequently used, least frequently used, and so forth) frequency band.

After selecting the codeword, the SPD may then transmit the selected codeword during a RTS period, such as the RTS period 325, of a superframe (block 610). Since the selected codeword and other possible codewords are orthogonal, even if other SPDs are also transmitting codewords, a collision will not occur unless other SPD selects a codeword identical to the selected codeword. However, even if a collision occurred, the SPDs involved in the transmission may not be able to detect the collision.

After transmitting the codeword, the SPD may listen for an acknowledgment (ACK) or a negative acknowledgment (NACK) from the PPD during an ANP, such as the ANP 330 (block 615). If the PPD decides to grant permission to the SPD, then the PPD may transmit an ACK during the ANP 330 by transmitting a codeword corresponding to the RTS codeword. For example, the PPD may transmit the codeword associated with the SPD to whom it has granted transmission permission. If the PPD decides to not grant permission to the SPD, then the PPD may transmit a NACK during the ANP 330. If multiple SPDs requested permission to transmit, the NACK may be indicative of the PPD not granting transmission permission to any of the SPDs. If the PPD transmits neither an ACK nor a NACK, then the SPD may consider that the PPD did not grant it permission to transmit the beacon.

If the SPD detects an ACK intended for the SPD in the ANP 330 (block 615), then the SPD has been granted permission to transmit its beacon and during a subsequent superframe, the SPD may transmit the beacon (block 620). If the SPD does not detect an ACK intended for the SPD, or if the SPD detects a NACK intended for all SPDs, or if the SPD detects no transmission at all during the ANP 330, then the SPD may wait a specified amount of time (block 625). The wait may used to help provide a measure of transmission traffic control as well as collision avoidance. The specified amount of time may be a value that is predetermined or a randomly selected duration, for example. After waiting the specified amount of time, the SPD may repeat the operations necessary to obtain permission to transmit its beacon.

FIG. 7a illustrates a sequence of events 700 in the generation of a codeword by an SPD or a PPD. As discussed previously, a codeword may be generated by concatenating more than one shorter length orthogonal sequences together. To generate a codeword, the SPD (or PPD) may first select a first portion of the codeword (block 705). The SPD (or PPD) may select the first portion from a set of possible first portions. For example, the SPD (or PPD) may select one of eight length eight orthogonal sequences. The SPD (or PPD) may then select a second portion of the codeword (block 710). The SPD (or PPD) may select the second portion from a set of possible second portions. The set of possible first portions may potentially be identical to the set of possible second portions. Alternatively, the set of possible first portions may be different from the set of possible second portions, even if the first portion and the second portion have identical sequence lengths.

After the SPD (or PPD) selects the first portion and the second portion of the codeword, the codeword may then be generated by concatenating the first portion and the second portion together (block 715). Although the sequence of events 700 illustrates the generation of a codeword by concatenating two shorter length sequences, the sequence of events 700 may readily be extended to the generation of a codeword by concatenating more than two shorter length sequences, with the shorter length sequences having the same or different lengths. Therefore, the discussion of the concatenation of two shorter length sequences should not be considered as being limiting to either the scope or the spirit of the embodiments.

FIG. 7b illustrates a sequence of events 750 in the determining of a received codeword. The sequence of events 750 may be illustrative of events taking place in a PPD of a wireless network, such as the PPD 215 of the wireless network 200, after it has received a codeword. After receiving a codeword, the PPD 215 may need to determine the codeword in order to determine if it should grant an SPD that transmitted the codeword permission to transmit its beacon.

The determining of the received codeword may begin with a determining of a first portion of the codeword (block 755). The PPD 215 may determine the first portion of the received codeword by correlating the first portion of the received codeword with each orthogonal sequence from a set of possible first portions. After performing the multiple correlations, the PPD 215 may select the orthogonal sequence from the set of possible first portions having a highest correlation value as the first portion of the codeword.

The PPD 215 may then determine a second portion of the codeword (block 760). The PPD 215 may determine the second portion of the codeword by correlating the second portion of the received codeword with each orthogonal sequence from a set of possible second portions. After performing the multiple correlations, the PPD 215 may select the orthogonal sequence from the set of possible second portions resulting in a highest correlation value as the second portion of the codeword.

After determining the first portion of the codeword and the second portion of the codeword, the PPD 215 may combine the first and the second portions into the codeword (block 765). Alternatively, rather than storing actual orthogonal sequences as it determines the first portion and the second portion, the PPD 215 may store indices that may be used to access the orthogonal sequences in the set of possible first portions and the set of possible second portions, respectively. The indices may then be used to combine the orthogonal sequences into the codeword.

Although the sequence of events 750 illustrates the determining of a codeword by determining two shorter length sequences, the sequence of events 750 may readily be extended to the determining of a codeword by individually determining more than two shorter length sequences, with the shorter length sequences having the same or different lengths. Therefore, the discussion of the determining of two shorter length sequences should not be considered as being limiting to either the scope or the spirit of the embodiments.

The sequence of events 750 illustrates the determining of a codeword by determining two shorter length sequences in a PPD. The sequence of events 750 may also be applicable in the determining of a codeword by determining two shorter length sequences in an SPD. Therefore, the discussion of the determining of the codeword in a PPD should not be considered as being limiting to either the scope or the spirit of the embodiments.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for transmitting data, the method comprising:
generating a codeword, wherein the generating comprises concatenating a first portion of the codeword with a second portion of the codeword;
transmitting the codeword to a communications controller;
transmitting data in response to a determining that an acknowledgment to the codeword has been received; and
waiting a period of time in response to a determining that no acknowledgment to the codeword has been received.

2. The method of claim 1, wherein the waiting further comprises repeating the generating and the transmitting the codeword.

3. The method of claim 1, wherein the generating comprises:
selecting a first portion from a set of possible first portions; and
selecting a second portion from a set of possible second portions.

4. The method of claim 3, wherein the first portion comprises an orthogonal sequence of length N, and the second portion comprises an orthogonal sequence of length M.

5. The method of claim 4, wherein N is equal to M.

6. The method of claim 5, wherein the set of possible first portions is equal to the set of possible second portions.

7. The method of claim 4, wherein codeword is a length 16 orthogonal sequence, the first portion and the second portion are length eight orthogonal sequences, and wherein the first portion and the second portion are Walsh codes.

8. The method of claim 7, wherein the set of possible first portions and the set of possible second portions each comprises the following sequences:

| Sequence | |
|---|---|
| Index | Sequence |
| 1 | 0 0 0 0 0 0 0 0 |
| 2 | 0 1 0 1 0 1 0 1 |
| 3 | 0 0 1 1 0 0 1 1 |
| 4 | 0 1 1 0 0 1 1 0 |
| 5 | 0 0 0 0 1 1 1 1 |
| 6 | 0 1 0 1 1 0 1 0 |
| 7 | 0 0 1 1 1 1 0 0 |
| 8 | 0 1 1 0 1 0 0 1 |

9. The method of claim 1, wherein the waiting comprises waiting a randomly selected period of time.

10. A method for wireless communications, the method comprising:
receiving a transmission permission request from a secondary device during a first transmission slot of a first communications period, wherein the transmission permission request comprises a codeword generated by concatenating two sequences shorter in length than the codeword;
decoding the transmission permission request;
responding to the transmission permission request in a second transmission slot in response to a determining that a decision on the transmission permission request has been made; and
receiving a transmission in a second communications period.

11. The method of claim 10, wherein transmission permission request comprises an orthogonal sequence, and wherein the decoding comprises:
correlating a first portion of the orthogonal sequence with each first portion sequence in a set of possible first portion sequences;
selecting a first portion sequence resulting in a highest correlation value;
correlating a second portion of the orthogonal sequence with each second portion sequence in a set of possible second portion sequences;
selecting a second portion sequence resulting in a highest correlation value;
concatenating the first portion sequence and the second portion sequence.

12. The method of claim 10, wherein the second communications period is a communications period immediately following the first communications period.

13. The method of claim 10, wherein the transmission permission request comprises a codeword generated by selecting a first portion from a set of possible first portion sequences and a second portion from a set of possible second portion sequences.

14. The method of claim 10, wherein the receiving the transmission permission request and the responding to the transmission permission request occurs in the first communications period.

15. A communications network comprising:
a primary protecting device configured to control transmissions taking place in the communications network and to signal communications information to communications devices not part of the communications network for the purpose of protecting communications of communications devices associated with the communications network; and
a secondary protecting device wirelessly coupled to the primary protecting device, the secondary protecting device configured to protect a communications device associated with the communications network by transmitting communications information to the primary protecting device after obtaining permission to transmit by transmitting a codeword generated by concatenating two sequences having lengths shorter than the codeword.

16. The communications network of claim 15, wherein the primary protecting device comprises:
a transmitter to transmit signals over the air; and
a receiver to receive transmissions, the receiver comprising,
a demodulator configured to demodulate a received signal provided by a signal input,
a codeword detector coupled to the demodulator, the codeword detector configured to determine a received codeword contained in the received signal, the codeword detector comprising,
a correlator configured to separately correlate each of the two sequences with a set of possible sequences, and
a first codeword buffer coupled to the correlator, the second codeword buffer to store the received codeword as it is being determined, and
a memory coupled to the codeword detector, the memory to store the set of possible sequences.

17. The communications network of claim 15, wherein the secondary protecting device comprises:
a receiver to receive transmissions; and
a transmitter to transmit signals, the transmitter comprising,
a codeword generator configured to generate a codeword by concatenating two sequences, the codeword generator comprises,
a codeword selector configured to select a possible sequence from a set of possible sequences for each of the two sequences, and
a second codeword buffer coupled to the codeword selector, the second codeword buffer to store the codeword as it is being generated,
a memory coupled to the codeword generator, the memory to store the set of possible sequences, and
a modulator coupled to the codeword generator, the modulator configured to modulate the codeword for transmission.

18. The communications network of claim 15, wherein the two sequences are selected from the set of possible sequences, and wherein the set of possible sequences comprises:

| Sequence | |
|---|---|
| Index | Sequence |
| 1 | 0 0 0 0 0 0 0 0 |
| 2 | 0 1 0 1 0 1 0 1 |
| 3 | 0 0 1 1 0 0 1 1 |
| 4 | 0 1 1 0 0 1 1 0 |
| 5 | 0 0 0 0 1 1 1 1 |
| 6 | 0 1 0 1 1 0 1 0 |
| 7 | 0 0 1 1 1 1 0 0 |
| 8 | 0 1 1 0 1 0 0 1 |

19. The communications network of claim 15, wherein the communications devices associated with the communications network comprises licensed communications devices communicating over licensed spectrum.

20. The communications network of claim 15, wherein the communications devices not part of the communications network comprises unlicensed communications devices communicating over licensed spectrum.
